(19) United States
(12) Patent Application Publication
(10) Pub. No.: US 2003/0108698 A1
(43) Pub. Date: Jun. 12, 2003

(54) Shrink sleeve for contoured articles

(75) Inventors: David E. Johnson, Dawsonville, GA (US); Clarence B. Jacobs, Alpharetta, GA (US)

Correspondence Address: KENNETH S WATKINS JR, 372 RIVER DR, DAHLONEGA, GA, 30533, US

(73) Assignee: SleeveCo, Inc.

(21) Appl. No.: 10/015,062

(22) Filed: Dec. 11, 2001

(51) Int. Cl. B32B 1/02; B29C 61/02

(52) U.S. Cl. 428/35.1; 264/132; 264/230

(57) ABSTRACT

A shrink sleeve [101] for a contoured article [103] is made of a preferentially orientated shrink film [102]. The sleeve comprises a contoured side seam [104] defining a contoured shape portion similar to the shape of the contoured article. The contoured shape of the sleeve allows use of lower ratio shrink films and reduces distortion of printing 101F in the contoured shape portion of the sleeve.

### FIELD OF THE INVENTION

The present invention relates to shrink sleeves for inserting over and heat shrinking onto articles and, more particularly, to shrink sleeves for use with contoured articles.

### BACKGROUND OF THE INVENTION

Shrink sleeves have proven useful for packaging, displaying and labeling articles such as containers, toys, appliances and tools. Shrink sleeves offer a low cost means of protecting articles and providing security such as tamper-resistant features. Preprinted sleeves offer a low cost means to improve appearance, and provide necessary product information.

Shrink sleeves are typically made from seamed or seamless tubes. When high quality graphics are desired, shrink film is normally pre-printed to allow full front and back side graphics. After printing, a welded or solvent-sealed seam provides a longitudinal seam, forming the sleeve.

Traditional shrink sleeves are rectangular in the lay flat condition and provide the best results with cylindrical or other solid shapes with relatively constant perimeter or outer circumference as a function of article height. This is especially important with printed graphics such as text or images, since non-uniform shrinkage occurs when shrunk over the article causes distortion of the graphics. Some distortion is normally acceptable and can be compensated for in the printing process. In some articles, such as contoured containers or bottles with pour spouts, the resulting differences in the transverse circumference of the article along the height or length of the sleeve results in excessive printing distortion, especially in the highly contoured portions. Even on non-printed sleeves, highly contoured articles requiring high shrink ratio films will result in wrinkling, poor visual qualities of the article, and high sleeve stress concentrations in the highly contoured portions of the article.

### OBJECTS AND SUMMARY OF THE INVENTION

Therefore, an object of the present invention is to provide a shrink sleeve for use with contoured articles that provides improved visual qualities as compared with conventional shrink sleeves.

Another object of the present invention is to provide a shrink sleeve for use with contoured articles that allows high quality sleeve graphics in highly contoured portions of the article.

Another object of the present invention is to provide a contoured shrink sleeve for use with contoured articles that allows use of low cost, lower shrink films as compared with conventional shrink sleeves.

Yet another object of the present invention is to provide a shrink sleeve for use with contoured articles that reduces sleeve stress concentrations as compared to conventional shrink sleeves.

For purposes of this disclosure, a shrink sleeve is defined as a generally tubular structure defining a longitudinal direction and a transverse direction and made of a heat shrinkable film and having an open top and an open bottom.

Preferentially orientated film is defined as a film having the greatest shrinkage in a defined direction, normally the transverse direction in a finished shrink sleeve and perpendicular to the longitudinal direction of the sleeve.

Shrink ratio is defined as the original length of a non-shrunk portion of heat shrinkable film in the defined direction divided by the free-shrunk length of the film in the defined direction after subjected to a shrinkage treatment such as a heat treatment.

The shrink sleeve of the present invention is made of a preferentially orientated heat shrink film and has a non-uniform lay flat width (or transverse circumference) corresponding to the non-uniform transverse circumference of a contoured article when the shrink sleeve is in the desired location on the article. The shrink ratio of the film may be selected to be as low as the largest ratio of the transverse circumference of the shrink sleeve to the transverse circumference of the contoured article at the desired location of placement on the article. In the preferred embodiments, the shrink ratio is selected to be greater than the largest ratio of the transverse circumference of the shrink sleeve to the transverse circumference of the contoured article at the desired location of placement on the article. This shrink ratio film will provide tight, wrinkle-free sleeve installation upon heat shrinkage of the sleeve on the article.

The contoured shrink sleeve is especially useful on asymmetric packages such as containers having pour spouts. These articles normally have large differences in the transverse circumference of the pour area of the container as compared to the lower body of the container. Conventional shrink sleeves require large shrink ratios in the transverse direction in order to maintain a tight fit of the sleeve after shrinking. Large shrink ratio film is more costly, and results in wrinkles and distorted printing in the necked down or pour spout area. In some applications, the ratio of the maximum transverse circumference of the article to the minimum transverse circumference is greater than the available shrink ratio films. Conventional shrink sleeves would not provide tight sleeve fit in minimum circumference portions with such articles.

In the preferred embodiments, the shrink film is pre-printed in any desired location, including the lowest circumference portions of the contoured article. In conventional, rectangular lay flat sleeves, minimum circumference portions of the article correspond to large shrinkage portions, resulting in severe deformation of graphics printed on the sleeve. Contouring of the sleeve allows minimal shrinkage of the sleeve in the desired print locations, allowing increased flexibility in graphics design of the sleeve.

Contoured shrink sleeves also allows reduction of the shrink ratio necessary for contoured articles. Lower shrinkage film results in lower shrink sleeve costs, thinner shrink films, as well as reduction of shrinkage temperature and time compared with non-contoured sleeves.

### BRIEF DESCRIPTION OF THE DRAWINGS

These and other features, aspects and advantages of the present invention will become better understood with regard to the following description, appended claims and accompanying drawings where:

FIG. 1A is a perspective drawing of a contoured heat shrink sleeve and a contoured article for use with the sleeve, the contoured sleeve and contoured article being asymmetric;

FIG. 1B is a perspective drawing of the contoured shrink sleeve of FIG. 1A inserted over the contoured article, and heat being applied to the heat shrink sleeve;

FIG. 1C is a perspective drawing of the contoured shrink sleeve of FIG. 1A fully shrunk over the contoured article of FIG. 1A.

FIG. 2A is a top view of a contoured shrink sleeve in a lay flat condition, the contoured shrink sleeve having a concave side seam portion and a convex side seam portion;

FIGS. 2B-2F are top views of additional embodiments of a contoured shrink sleeve in a lay flat condition; and

FIG. 3 is a front elevation drawing of a contoured shrink sleeve having a minimum transverse circumference located between an upper maximum transverse circumference and a lower maximum transverse circumference, and a front elevation drawing of a contoured tubular article.

### DESCRIPTION OF THE PREFERRED EMBODIMENTS

The following is a description of the preferred embodiments of a shrink sleeve for contoured articles or articles.

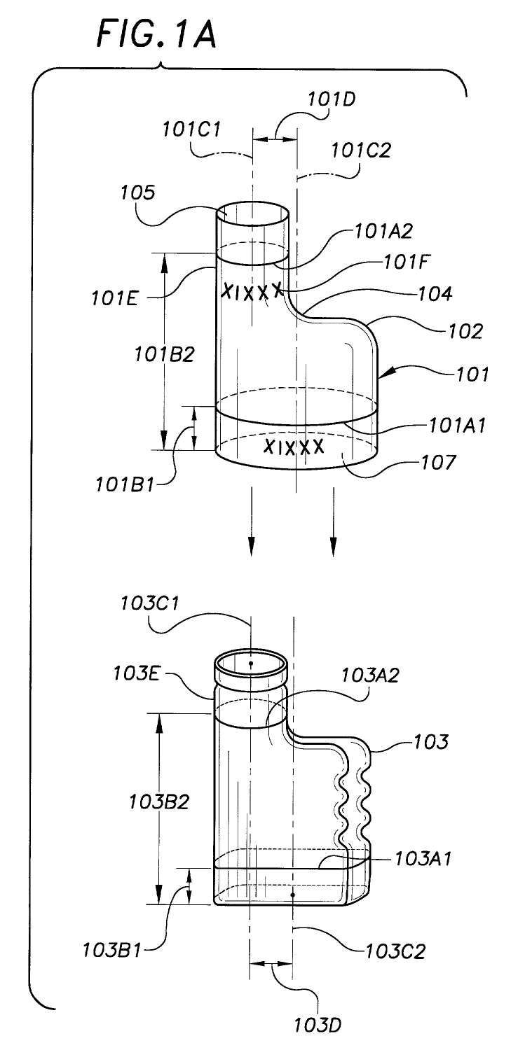

FIG. 1A is a perspective drawing of a shrink sleeve 101 of the present invention for use with a contoured article such as pour container 103. Container 103 comprises a variable outer transverse circumference 103A1, 103A2 as a function of height 103B1, 103B2.

In one aspect of the invention, contoured container 103 is asymmetric resulting in a geometric or centroidal upper vertical axis 103C1 transversely displaced by distance 103D from a geometric or centroidal lower vertical axis 103C2. In the preferred embodiments, sleeve 101 is also contoured, having a shape similar to contoured container 103 in the desired area of application.

Sleeve 101 is asymmetric, having a geometric or centroidal upper vertical axis 101C1 transversely displaced by transverse distance 101D from geometric or centroidal lower vertical axis 101C2. A contoured side seam 104 defines a contoured shape of the sleeve conforming to the contoured shape of container 103. In a preferred embodiment of the present invention, sleeve 101 comprises an open top 105 and an open bottom 107. The circumference, or alternatively, the lay flat width of sleeve 101 varies with height.

In the preferred embodiments, circumference 101A1 of sleeve 101 is greater than circumference 103A1 of article 103. Height 101B1 of sleeve 101 corresponds to height 103B1 of article 103 when sleeve 101 is in the desired area of application on container 103. Likewise, circumference 101A2 of sleeve 101 is greater than circumference 103A2 of article 103. Height 101B2 of sleeve 101 corresponds to height 103B2 of article 103 when sleeve 101 is in the desired area of application on container 103. In the preferred embodiments, distance 101D is equal to, or greater than, distance 103D.

The greater circumferences 101A1, 101A2, and axis offset distance 101D of sleeve 101 as compared to corresponding circumferences 103A1, 103A2 and axis offset distance 103D allow sleeve 101 to be easily positioned in the desired area of application over container 103 by manual or automated means as shown in FIG. 1B. Once sleeve 101 is positioned in the desired area of application, a heat means such as heat guns 111 apply heat to sleeve 101, shrinking sleeve 101 tightly around container 103 as shown in FIG. 1C.

The contoured shape of sleeve 101 to conform to the contoured shape of container 103 allows use of lower shrinkage film as compared with non-contoured shape sleeves. Contoured shape sleeve 101 also reduces wrinkling and improves esthetic appearance of sleeve 101 when shrunk over contoured containers, especially when the container is asymmetric as defined by traverse axial displacement 103D.

Another advantage of contouring sleeve 101 to the general contour of container 103 is improved graphics due to reduction of film shrinkage in reduced circumference portions of the sleeve. For example, use of a non-contoured sleeve, such as right circular tube sleeve for sleeve 101 (corresponding to a rectangular sleeve in the lay-flat condition) would result in high shrinkage in necked area 103E of container 103. Graphics, especially text or images would become undesirable distorted by use of high-shrink films in conjunction with circumferences which vary widely on the container. The contoured shape of sleeve 101 reduces film shrinkage in necked-down portions of container 103 such as portion 103E, and allows high quality graphics 101F on necked area 101E of sleeve 101.

In the preferred embodiments, the product of the ratio of the maximum circumference of the contoured sleeve to the minimum circumference of the sleeve (the sleeve circumference ratio) and the shrink ratio of the film is equal to, or greater than, the ratio of the maximum circumference of the corresponding covered portion of the contoured article to the minimum circumference of the corresponding portion of the contoured article (the article circumference ratio).

(sleeve circumference ratio)×(film shrink ratio)≧(article circumference ratio)

For the example of FIG. 1A:

(101A1/101A2)×(film shrink ratio)≧(103A1/103A2)

Selection of contoured sleeves ratios and film shrink ratios for contoured articles as described by this process will result in tight fit of the shrunk sleeve on the contoured article throughout the covered portion.

In the preferred embodiments, the film shrink ratios will be minimized for large ratio contoured articles by use of large ratio contoured sleeves. For example, film ratios of less than 2 can be used with contoured articles having circumference ratios in the covered portion of up to 8 by use of contoured shrink sleeves having circumference ratios of at least 4.

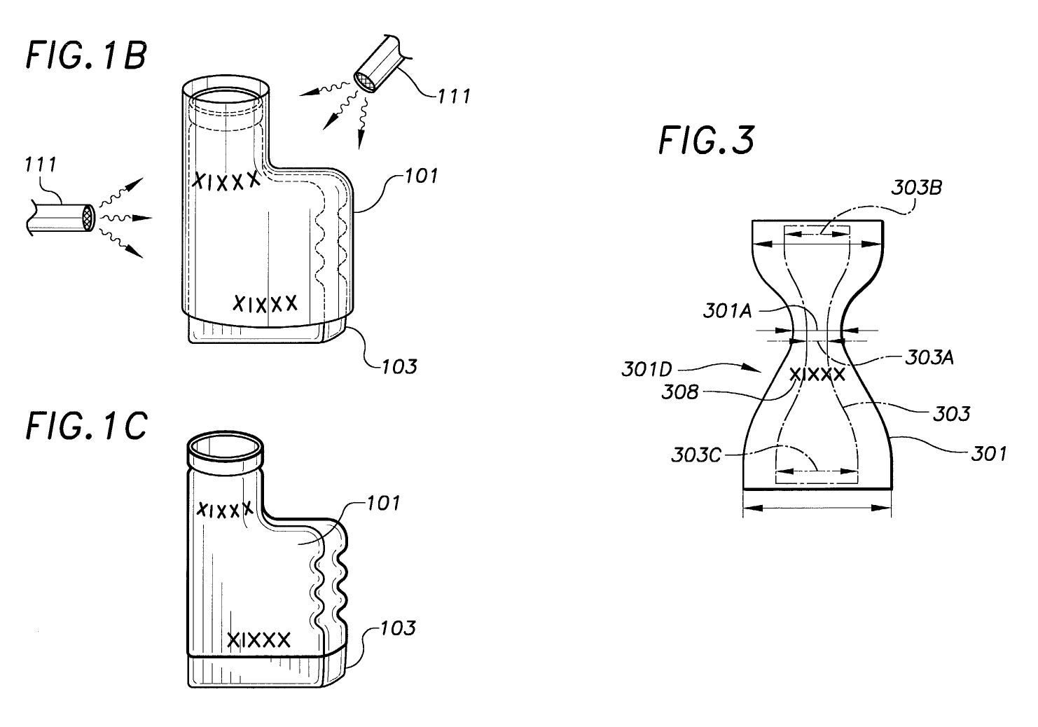

FIG. 2A-FIG. 2F show alternative embodiments of contoured sleeves in lay flat conditions. Contoured sleeve 201 of FIG. 2A comprises a concave contoured portion 201A and a convex contoured portion 201B. Contoured sleeve 203 of FIG. 2B is made up of two concave contoured portions 203A and 203B. Sleeve 205 of FIG. 2C comprises angled portion 205A which forms an obtuse angle 205B with vertical side 205C.

Sleeve 207 of FIG. 2D comprises two angled portions 207A and 207B which form obtuse angles 207C, 207D with corresponding side portions 207E and 207F. Sleeve 209 of FIG. 2E comprises two side portions 209A and 209B which form acute angles 209C, 209D, with bottom 209E. Sleeve 211 comprises two convex side portions 211A and 211B between top 211C and bottom 211D.

In each of the examples, the sleeve comprises a minimum lay flat width less than a maximum lay flat width when used with a contoured article such as a package, container, or bundle of articles. The ratio of the maximum lay flat width, such as 201C of FIG. 2A divided by the minimum lay flat width 201D defines a lay flat ratio of the sleeve numerically equal to the circumference ratio of the sleeve as defined earlier.

In the preferred embodiments, the contour of the sleeve is adjusted so that the difference in the circumference of the sleeve is no more than 50 percent of the circumference of the necked down portion of the package, container or bundle of articles if printing such as graphics 203C of FIG. 2B is utilized on contoured portions 203D of the sleeve. In the more preferred embodiments, the contour of the sleeve is adjusted so that the difference in the circumference of the sleeve is no more than 20 percent of the circumference of the necked down portion of the package, container or bundle of articles if printing such as graphics 203C of FIG. 2C is utilized on contoured portions 203D of the sleeve. The bottom of sleeves of FIGS. 2A-2F are open. In the preferred embodiments, the top and bottoms of the sleeves are open.

The contoured portions of the shrink sleeves of the present invention may be made by welding such as hot bar or die seals or ultrasonically produced seals. Or, the contoured portions of the shrink sleeves may be made by adhesive or solvent seal means known in the art.

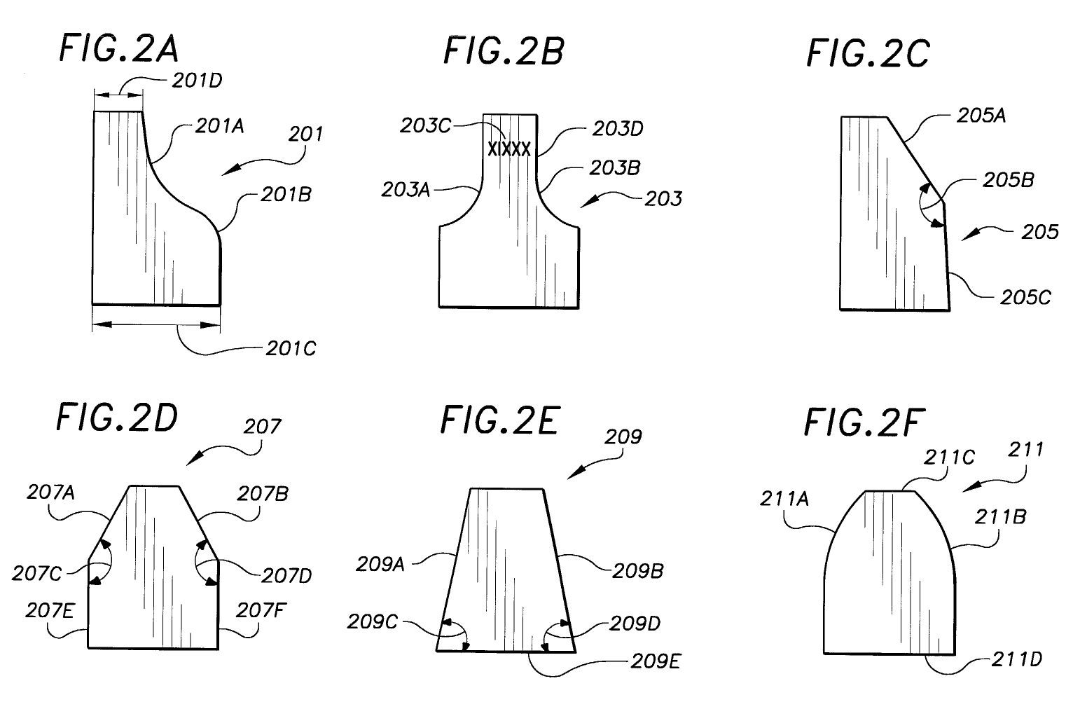

FIG. 3 shows use of a contoured shrink sleeve 301 with a contoured article 303. Article 303 has a portion of minimum circumference 303A less than an upper maximum circumference 303B or a lower maximum circumference 303C.

In the preferred embodiments of contoured shrink sleeve 301, minimum circumference 301A of sleeve 301 is greater than upper maximum circumference 303B or lower maximum circumference 303C. In this way, sleeve 301 may be applied over at least one end of article 303 without stretch of sleeve 301. Contoured sleeve 301 allows printing, such as graphics 308 in minimum circumference area 301D with minimum distortion resulting from installation and shrinking of sleeve 301 on article 303.

In the preferred embodiments of the invention, preferentially-orientated film (102 of FIG. 1A) is used for the contoured sleeves. The film may be polyvinyl chloride (PVC), polyethylene (PE), polypropylene (PP), other polyolefins and copolymers, polyesters (PETG, OPETE) and polystyrene (OPS). In the preferred embodiments, the major shrink axis is transverse to the longitudinal axis of the sleeve.

Contoured sleeves allow use of lower shrink films when used with contoured articles or bundles as compared to non-contoured sleeves such as sleeves having a rectangular lay-flat condition. In the preferred embodiments, orientated films having shrink ratios of less than 4.0 are used. In the more preferred embodiments, orientated films having shrink ratios of less than 3.0 are used. In the still more preferred embodiments, orientated films having shrink ratios of less than 2.0 are used. In the most preferred embodiments, orientated films having shrink ratios of less than 1.5 are used. In other embodiments, films may be non-orientated.

Accordingly, the reader will see that the contoured sleeve of the present invention provides improved appearance shrink sleeves for contoured articles. The sleeves provide the following additional advantages:

Cost savings resulting from use of lower-shrinkage films as compared to non-contoured sleeves.

Reduced distortion of graphics printed on the sleeves of contoured articles; and

Application on highly contoured articles as compared to conventional sleeves.

Although the description above contains many specifications, these should not be construed as limiting the scope of the invention but merely providing illustrations of some of the presently preferred embodiments of this invention. Thus the scope of the invention should be determined by the appended claims and their legal equivalents, rather than by the examples given.

We claim:

1. A shrink sleeve for heat shrinking over an asymmetrically contoured article, the sleeve made of a preferentially orientated film and comprising:
an open bottom defining a vertical bottom axis and an open top defining a vertical top axis, the top axis offset transversely from the bottom axis.

2. The shrink sleeve of claim 1 comprising a contoured side seam defining a contoured shape portion when the sleeve is in a lay-flat condition, the contoured shape portion disposed between the open top and the open bottom and comprising a non-uniform lay-flat width.

3. The shrink sleeve of claim 1 wherein the contoured shape portion comprises a concave-shaped portion.

4. The shrink sleeve of claim 1 wherein the contoured shape portion comprises a convex-shaped portion.

5. The shrink sleeve of claim 1 wherein the contoured shape portion comprises a convex-shaped portion and a concave-shaped portion.

6. The shrink sleeve of claim 1 wherein the shrink sleeve comprises a first side in a lay-flat condition, the first side having a vertical portion and an angled portion disposed between the vertical portion and the open top, the angled portion forming an obtuse angle with the vertical portion.

7. The shrink sleeve of claim 2 wherein the contoured shape portion comprises a printed surface.

8. The shrink sleeve of claim 7 wherein the printed surface comprises graphics.

9. The shrink sleeve of claim 8 wherein the film is made of a shrink material selected from the group of PVC, PE, PETG, OPETE and OPS.

10. A shrink sleeve for use with a contoured article, the contoured article comprising a maximum transverse circumference in a sleeve coverable portion of the article and a minimum transverse circumference in the sleeve coverable portion, the maximum circumference in the sleeve coverable portion divided by the minimum circumference in the sleeve coverable portion defining a article circumference ratio greater than 1.0, the sleeve made of a preferentially orientated shrink film comprising a transverse shrink ratio defined by the before-shrunk dimension of the film divided by the free-shrunk dimension in the orientated direction and:
a contoured side seam defining a contoured shape portion when the sleeve is in a lay-flat condition, the contoured shape portion disposed between an open top and an open bottom, the shrink sleeve comprising a maximum transverse circumference and a minimum transverse circumference, the maximum circumference of the sleeve divided by the minimum circumference of the sleeve defining a sleeve circumference ratio greater than 1.0;
wherein the shrink ratio of the film is less than the article circumference ratio.

11. The shrink sleeve of claim 10 wherein the contoured shape portion comprises a printed surface portion.

12. The shrink sleeve of claim 11 wherein the printed surface portion comprises graphics.

13. The shrink sleeve of claim 12 wherein the printed surface portion comprises text.

14. The shrink sleeve of claim 10 wherein the article circumference ratio is greater than 4.0.

15. The shrink sleeve of claim 10 wherein the article circumference ratio is greater than 6.0.

16. The shrink sleeve of claim 10 wherein the article circumference ratio is greater than 8.0.

17. The shrink sleeve of claim 10 wherein the sleeve circumference ratio is greater than 2.0.

18. The shrink sleeve of claim 10 wherein the article circumference ratio is greater than 4.0 and the film shrink ratio is less than 2.0.

19. A method of reducing print distortion on a shrink sleeve for a contoured shape article, the method comprising the steps of:
printing a preferentially orientated film to define a printed surface portion in the film, forming a seal on the shrink film to define a sleeve, the sleeve comprising a contoured shape portion when the sleeve is in a lay-flat condition, the contoured shape portion disposed between a top and a bottom of the sleeve and comprising a non-uniform lay-flat width corresponding to a contour of the contoured shape article, at least a portion of the printed surface being on the contoured shape portion.

20. The method of claim 14 wherein the printed surface portion comprises graphics.

21. The method of claim 15 comprising the additional step of:
inserting the sleeve on the contoured shape article.

22. The method of claim 16 comprising the additional step of:
heat-shrinking the sleeve onto the contoured shape article.

23. A shrink sleeve for use with a contoured article, the sleeve made of a preferentially orientated shrink film and comprising:
a top portion comprising a maximum upper transverse circumference;
a bottom portion comprising a maximum lower transverse circumference;
a contoured seam portion defining a reduced circumference portion comprising a minimum circumference less than either of the maximum upper circumference and the maximum lower circumference, the reduced circumference portion disposed between the top portion and the bottom portion.

24. The shrink sleeve of claim 23 wherein the preferentially orientated film comprises shrink ratio at least equal to the ratio of the lesser of the maximum top lay flat width and the maximum bottom lay flat width to the minimum lay flat width.

25. The shrink sleeve of claim 23 wherein the reduced circumference portion comprises printed graphics.

26. A method of reducing the shrink ratio of a shrink sleeve film for use with a contoured shape article, the method comprising the steps of:
forming a seal on the shrink film to define a sleeve, the seal defining a contoured shape portion when the sleeve is in a lay-flat condition, the contoured shape portion disposed between a top and a bottom of the sleeve and comprising a non-uniform lay-flat width corresponding to a contour of the contoured shape article;
selecting a shrink ratio of the shrink sleeve film to be less than an article circumference ratio defined as the maximum transverse circumference in a sleeve coverable portion of the article divided by a minimum transverse circumference in the sleeve coverable portion.
